(19) United States
(12) Patent Application Publication
(10) Pub. No.: US 2012/0259465 A1
(43) Pub. Date: Oct. 11, 2012

(54) CLEANING SYSTEM

(76) Inventors: Shui-Shih CHEN, Changhua County (TW); You-Wei Teng, New Taipei City (TW)

(21) Appl. No.: 13/114,128

(22) Filed: May 24, 2011

(30) Foreign Application Priority Data
Apr. 11, 2011 (TW) 100112410

(51) Int. Cl. G06F 7/00

(52) U.S. Cl. 700/259; 901/1; 901/47

(57) ABSTRACT

A cleaning system including a first virtual wall, a second virtual wall and a cleaning robot is disclosed. The first virtual wall includes a first specific pattern. When a light emits the first specific pattern, a first specific reflected light is generated. The second virtual wall includes a second specific pattern. When the light emits the second specific pattern, a second specific reflected light is generated. The cleaning robot, based on the first and the second specific reflected lights, obtains and records positions of the first and the second virtual walls. The cleaning robot defines a first virtual line according to the recorded positions. A traveling path of the cleaning robot is limited by the first virtual line.

### CROSS REFERENCE TO RELATED APPLICATIONS

This Application claims priority of Taiwan Patent Application No. 100112410, filed on Apr. 11, 2011, the entirety of which is incorporated by reference herein.

### BACKGROUND OF THE INVENTION

1. Field of the Invention

The invention relates to a cleaning system, and more particularly to a cleaning system with virtual walls, each comprising a specific pattern.

2. Description of the Related Art

Virtual walls can be divided into light virtual walls and magnetic virtual walls. The light virtual walls are divided into an active type and an inactive type. For the active type, the light virtual walls can actively emit light. When a cleaning robot receives the light emitted by the light virtual wall, the cleaning robot can obtain the position of the light virtual wall according to the received light. However, the light virtual wall is required to continuously emit light. Thus, the power consumption of the light virtual wall is large.

For the inactive type, the light virtual wall does not emit light until the light virtual wall receives wireless signals provided by a cleaning robot. The cleaning robot obtains the position of the light virtual wall according to the emitted light. Although the light virtual wall does not require continuous emission light, the light virtual wall still requires power consumption.

The magnetic virtual walls do not require power consumption. The magnetic virtual walls are disposed on the ground. When a cleaning robot approaches the magnetic virtual walls, a magnetic sensor of the cleaning robot detects the magnetic virtual walls. However, the positions of the magnetic virtual walls may be moved by the cleaning robot when the cleaning robot passes through the magnetic virtual walls.

A conventional method applies viscose to the back of the magnetic virtual wall to fix the position of the magnetic virtual wall. However, an adhesive magnetic virtual wall is not aesthetic. Additionally, if a user does not plan to utilize the adhesive magnetic virtual wall, and removes it, the adhesion of the magnetic virtual wall will be reduced.

### BRIEF SUMMARY OF THE INVENTION

In accordance with an embodiment, a cleaning system comprises a first virtual wall, a second virtual wall and a cleaning robot. The first virtual wall comprises a first specific pattern. When a light emits the first specific pattern, a first specific reflected light is generated. The second virtual wall comprises a second specific pattern. When the light emits the second specific pattern, a second specific reflected light is generated. The cleaning robot, based on the first and the second specific reflected lights, obtains and records positions of the first and the second virtual walls. The cleaning robot defines a first virtual line according to the recorded positions. A traveling path of the cleaning robot is limited by the first virtual line.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of a cleaning system of the invention;

FIGS. 2A and 2B are schematic diagrams of other exemplary embodiments of a specific pattern;

FIG. 3 is a schematic diagram of another exemplary embodiment of a cleaning system of the invention; and

FIG. 4 is a schematic diagram of another exemplary embodiment of a cleaning robot.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

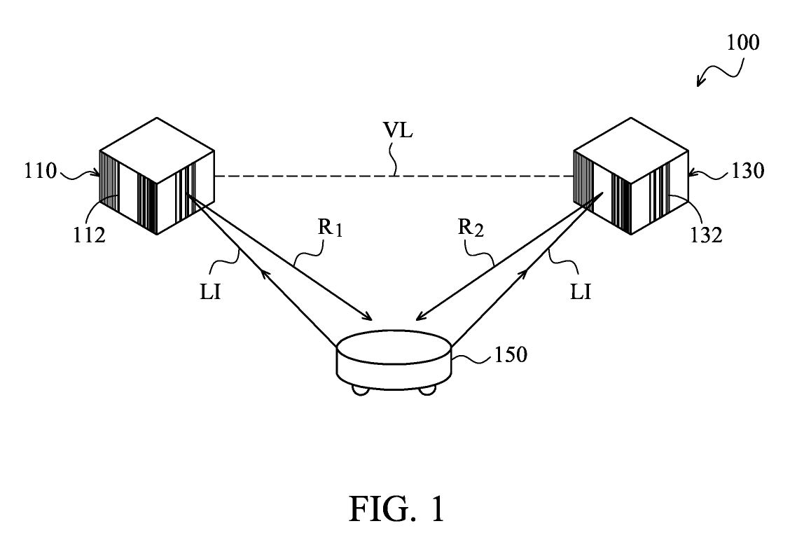

FIG. 1 is a schematic diagram of an exemplary embodiment of a cleaning system of the invention. The cleaning system 100 comprises virtual walls 110, 130 and a cleaning robot 150. The invention does not limit the number of the virtual walls. In one embodiment, the number of the virtual walls is more than 2. For clarity, only two virtual walls 110 and 130 are shown in FIG. 1.

The virtual wall 110 comprises a specific pattern 112. The virtual wall 130 comprises a specific pattern 132. In one embodiment, the specific pattern 112 is the same as the specific pattern 132. In another embodiment, the specific pattern 112 is different from the specific pattern 132.

Since the virtual wall 110 comprises the specific pattern 112, when a light LI emits the virtual wall 110, the light LI is reflected by the specific pattern 112 to generate a specific reflected light R₁. Similarly, since the virtual wall 130 comprises the specific pattern 132, when the light LI emits the virtual wall 130, the light LI is reflected by the specific pattern 132 to generate a specific reflected light R₂. Each of the specific reflected lights R₁ and R₂ comprises an encoding value. In one embodiment, if the specific pattern 112 is different from the specific pattern 132, the encoding value of the specific reflected light R₁ is different from the encoding value of the specific reflected light R₂.

The cleaning robot 150, based on the specific reflected light R₁ or R₂, obtains and records the position of the virtual wall 110 or 130. The cleaning robot 150 defines a virtual line VL according to the recorded positions and operates according to the virtual line VL. In this embodiment, the traveling path of the cleaning robot 150 is limited by the virtual line VL. In other words, the cleaning robot 150 does not pass through the virtual line VL.

The virtual walls 110 and 130 do not require emission of light or generate a magnetic field and are capable of providing specific reflected lights R₁ and R₂. Thus, in this embodiment, each of the virtual walls 110 and 130 does not consume power or raise a magnetic interference issue. Each of the virtual walls 110 and 130 does not have to be fixed on floors and can be arbitrarily moved. Thus, furnishings does not be influence by the virtual walls.

The invention does not limit the forms of the specific patterns 112 and 132. In one embodiment, the specific patterns 112 and 132 are barcode patterns. In other embodiments, the specific patterns 112 and 132 are character patterns or other patterns. In this embodiment, the shapes of the virtual walls 110 and 130 are long-cubes, but the disclosure is not limited thereto. In other embodiments, the virtual walls 110 and 130 are circular-cubes or other shapes.

To generate a specific reflected light, the specific pattern 112 is repeatedly printed on the entire surface of the virtual wall 110 and the specific pattern 113 is repeatedly printed on the entire surface of the virtual wall 130. Thus, no matter which angle the light LI is emitted on the specific pattern of the virtual wall, a specific reflected light will be generated. The different emitting angles provide the different reflected lights. The different reflected lights comprise the same intensity.

Furthermore, the size of the virtual wall 110 or 130 determines the intensity of the specific reflected light (R₁ or R₂). Thus, the size of the virtual wall 110 or 130 will be appropriately determined such that the intensity of the specific reflected light (R₁ or R₂) received by the cleaning robot 150 is not affected by the distance between the cleaning robot 150 and the virtual wall 110 or 130.

For example, when the cleaning robot 150 is far removed from the virtual wall 110, the light LI emitted by the cleaning robot 150 emits a portion of the specific pattern 112 of the virtual wall 110, wherein the emitted portion of the specific pattern 112 may be constituted by a black stripe, a white stripe, a black stripe, a black stripe and a white stripe. Since the light LI will be reflected by the emitted portion of the specific pattern 112, a specific reflected light R₁ is generated. When the cleaning robot 150 moves and approaches the virtual wall 110, the light LI emits another portion of the specific pattern 112 of the virtual wall 110, wherein the another portion of the specific pattern 112 also comprises a black stripe, a white stripe, a black stripe, a black stripe and a white stripe. Since the light LI will be reflected by another portion of the specific pattern 112, a specific reflected light R₂ is generated. Since the emitted patterns are the same, the specific reflected lights R₁ and R₂ comprise the same intensities.

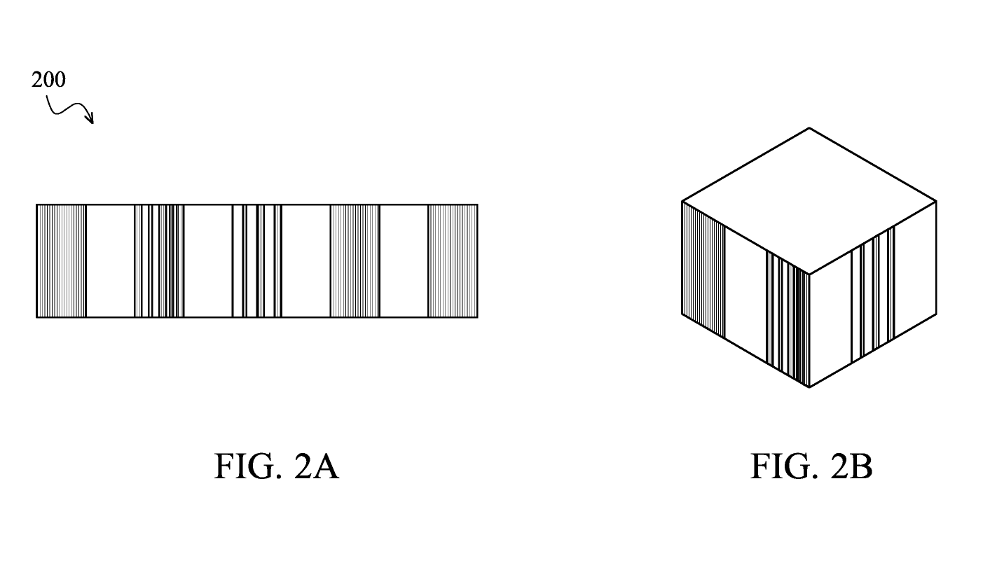

FIG. 2A is a schematic diagram of an exemplary embodiment of a specific pattern. In this embodiment, the specific pattern 200 comprises multi-stripes. When a cleaning robot is far removed from the specific pattern 200, the specific reflected light is generated by coarse stripes. At this time, the cleaning robot discovers the position of the virtual wall. When the cleaning robot moves and approaches the specific pattern 200, the specific reflected light is generated by fine stripes. The cleaning robot obtains an encoding value according to the intensity of the specific reflected light reflected by the fine stripes.

The specific pattern 200 can be printed on a cardboard. The cardboard is reduced to form a cube as shown in FIG. 2B. Since the virtual wall can be easily manufactured by a user, the convenience of the virtual wall is increased and the cost of the virtual wall is reduced. Additionally, the virtual wall is easily stored and does not affect home decor.

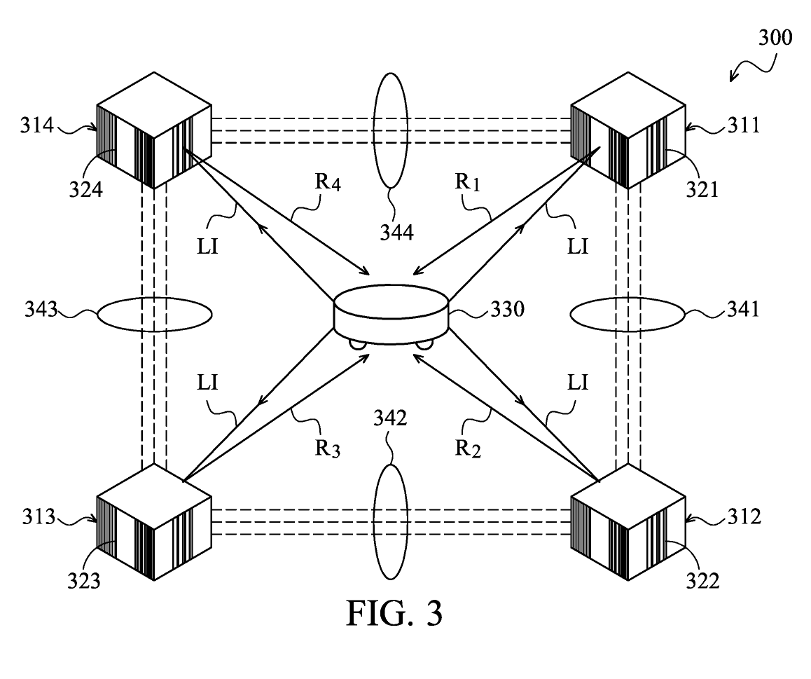

FIG. 3 is a schematic diagram of another exemplary embodiment of a cleaning system of the invention. The cleaning system 300 comprises four virtual walls 311˜314. Each of the virtual walls 311˜314 comprises a specific pattern (e.g. 321˜324). In this embodiment, the specific patterns 321˜324 are different.

When a light emits one of the specific patterns 321˜324, a specific reflected light is generated. The cleaning robot 330, based on the specific reflected lights R₁˜R₄, obtains different encoding values. The cleaning robot 330 encodes the virtual walls 311˜314 according to the different encoding values. In one embodiment, the virtual walls 311˜314 are respectively encoded into a first virtual wall, a second virtual wall, a third virtual wall and a four virtual wall. The cleaning robot 330 defines a plurality of virtual lines according to the encoded virtual walls 311˜314.

In one embodiment, one virtual wall with two neighboring virtual walls form two virtual lines. For example, the cleaning robot 330 defines a virtual line 341 between the virtual walls 311 and 312, defines another virtual line 342 between the virtual walls 312 and 313, defines another virtual line 343 between the virtual walls 313 and 314, and defines another virtual line 344 between the virtual walls 314 and 311.

A desired protection region can be defined by the virtual lines 341˜344. In this embodiment, the cleaning robot 330 operates within the desired protection region defined by the virtual lines 341˜344. In other embodiments, the cleaning robot 330 operates outside of the desired protection region defined by the virtual lines 341˜344. In other words, the cleaning robot 330 does not clean the desired protection region defined by the virtual lines 341˜344.

In this embodiment, each of the virtual lines 341˜344 does not comprise any obstacles or any stereo-walls, but the disclosure is not limited thereto. In other embodiments, one of the virtual lines 341˜344 may comprise one obstacle or one stereo-wall. For example, an obstacle (e.g. a chair) exists between the virtual walls 311 and 312. Although an obstacle exists between two virtual walls, the cleaning robot can define a virtual line between the virtual walls 311 and 312, wherein the virtual line may be an irregular line (non-straight line).

In another embodiment, before defining one virtual line, the cleaning robot 330 moves along a stereo-wall to obtain a outline of a cleaning region and determine the positions of the virtual walls. Then, the cleaning robot 330 defines one virtual line in the outline of the cleaning region according to the positions of the virtual walls.

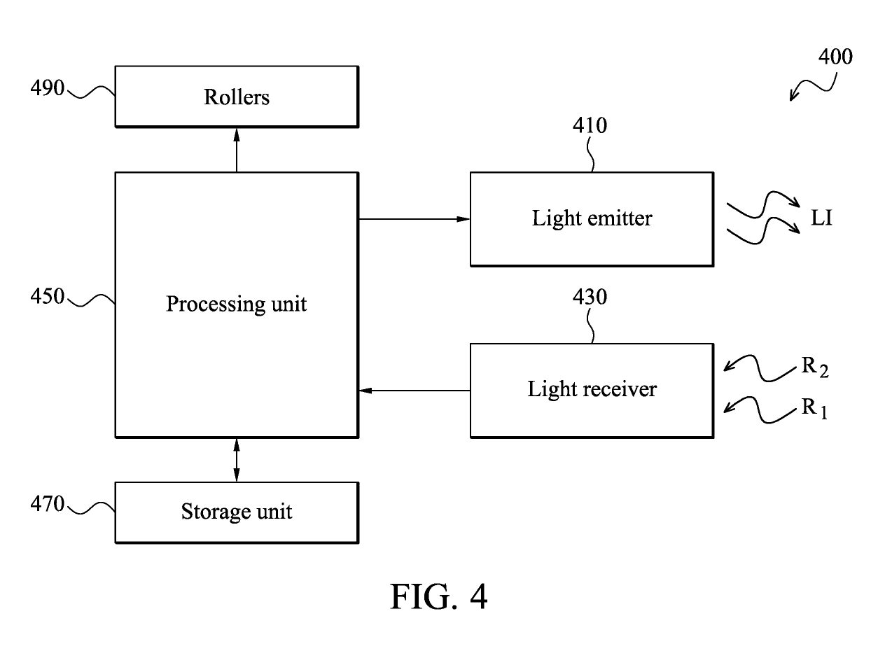

FIG. 4 is a schematic diagram of another exemplary embodiment of a cleaning robot. The cleaning robot 400 comprises a light emitter 410, a light receiver 430, a processing unit 450, a storage unit 470 and rollers 490.

The light emitter 410 emits a light LI. The light receiver 430 receives the specific reflected lights R₁ and R₂. The invention does not limit the kinds of the light emitter 410 and the light receiver 430. In one embodiment, the light LI emitted by the light emitter 410 and the reflected light received by the light receiver 430 are lasers, IRs or other beams.

The processing unit 450 drives the light emitter 410 to emit the light LI. The processing unit 450 obtains the positions of the virtual walls according to the specific reflected lights R₁ and R₂ received by the light receiver 430. The processing unit 450 records the obtained positions in the storage unit 470. In this embodiment, the processing unit 450 defines a virtual line according to the data stored in the storage unit 470. The processing unit 450 controls the rollers 490 so that they do not pass through the virtual line.

For generating the light LI, a light emitter serves as an example. In other embodiments, any device, which can cause the specific pattern to generate a reflected light, can serve as the light emitter 410. Similarly, to receive the specific reflected lights R₁ and R₂, the above description takes a light receiver as an example. In other embodiments, any device, which can process the reflected light, can replace the light receiver 430.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A cleaning system, comprising:
a first virtual wall comprising a first specific pattern, wherein when a light emits the first specific pattern, a first specific reflected light is generated;
a second virtual wall comprising a second specific pattern, wherein when the light emits the second specific pattern, a second specific reflected light is generated; and
a cleaning robot receiving the first and the second specific reflected lights and basing on the first and the second specific reflected lights to obtain and record positions of the first and the second virtual walls, wherein, the cleaning robot defines a first virtual line according to the recorded positions, and a traveling path of the cleaning robot is limited by the first virtual line.

2. The cleaning system as claimed in claim 1, wherein the first specific pattern is the same as the second specific pattern.

3. The cleaning system as claimed in claim 1, wherein the first specific pattern is different from the second specific pattern.

4. The cleaning system as claimed in claim 3, further comprising:
a third virtual wall comprising a third specific pattern, wherein when the light emits the third specific pattern, a third reflected light is generated, and the third specific pattern is different from the first and the second specific patterns,
wherein each of the first, the second and the third specific reflected lights comprises an encoding value, and the cleaning robot, based on the encoding values, defines the first virtual wall between the first and the second virtual walls, defines a second virtual wall between the second and the third virtual walls, and defines a third virtual wall between the third and the first virtual walls.

5. The cleaning system as claimed in claim 4, wherein a cleaning region is defined among the first, the second and the third virtual lines, and the cleaning robot operates in the cleaning region.

6. The cleaning system as claimed in claim 1, wherein the first virtual wall is a cube, and the first specific pattern is repeatedly printed on the entire surface of the cube.

7. The cleaning system as claimed in claim 1, wherein each of the first and the second virtual walls does not emit a light or generate a magnetic field.

8. The cleaning system as claimed in claim 1, wherein the cleaning robot comprises:
a light emitter emitting the light; and
a light receiver receiving the first and the second specific reflected lights.

9. The cleaning system as claimed in claim 8, wherein the light is a laser.
